(19) United States
(12) Patent Application Publication
(10) Pub. No.: US 2020/0272191 A1
(43) Pub. Date: Aug. 27, 2020

(54) CONTROL DEVICE HAVING BUTTON STRUCTURE

(71) Applicant: Goldtek Technology Co., Ltd., New Taipei City (TW)

(72) Inventors: SHIAN-WEN SHIU, New Taipei (TW); YU-CHIEN HU, New Taipei (TW); WU-HUNG YANG, New Taipei (TW)

(21) Appl. No.: 16/444,200

(22) Filed: Jun. 18, 2019

(30) Foreign Application Priority Data
Feb. 25, 2019 (TW) 108106357

(51) Int. Cl. G05G 5/05; G08B 3/10; G05G 1/02

(52) U.S. Cl. CPC G05G 5/05; G05G 2505/00; G05G 1/025; G08B 3/1008

(57) ABSTRACT

A control device includes a housing and a button received within the housing. The housing defines a through hole and a latching slot. The button defines a pressing portion and a resilient arm. The pressing portion is slidably mounted within the through hole. One end of the resilient arm is coupled to the pressing portion, and a second end of the resilient arm is latched within the latching slot. When the pressing portion is pressed, the pressing portion slides to trigger a signal transmitting mechanism within the housing to emit a signal and causes the resilient arm to deform. When the pressing portion is released, the resilient arm is resiliently restored to cause the pressing portion to return to an initial position.

### FIELD

The subject matter herein generally relates to control devices, and more particularly to a control device having a button structure.

### BACKGROUND

A control device, such as a doorbell, generally includes a signal transmitting mechanism, and the signal transmitting mechanism is triggered by a button structure to generate a doorbell sound when the button structure is pressed. Existing button structures are generally injection molded or welded. A button structure formed by injection molding may be difficult to form during molding, may be difficult to maintain, and have high cost. The welded button is prone to deviate in position, have high cost, and requires screws for disassembly and assembly.

### BRIEF DESCRIPTION OF THE DRAWINGS

Implementations of the present disclosure will now be described, by way of embodiments, with reference to the attached figures.

FIG. 1 is an assembled, isometric view of an embodiment of a control device.

FIG. 2 is similar to FIG. 1, but showing the control device from another angle.

FIG. 3 is an exploded view of the control device of claim 2.

FIG. 4 is a cross-sectional view of the control device taken along line IV-IV in FIG. 2.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a column, but can have one or more deviations from a true column. The term “comprising” means “including, but not necessarily limited to”; it specifically indicates open-ended inclusion or membership in a so-described combination, group, series and the like.

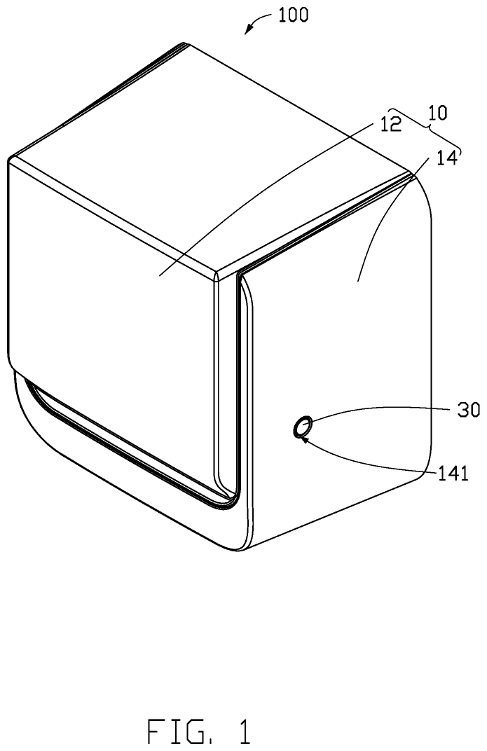

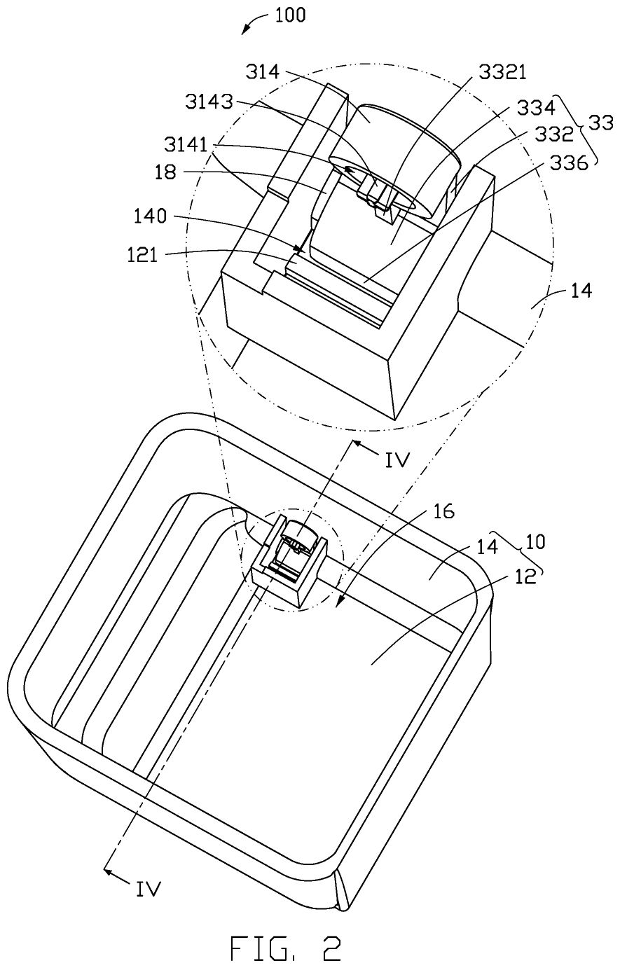

FIG. 1 and FIG. 2 show an embodiment of a control device 100. In the illustrated embodiment, the control device 100 is a doorbell, but is not limited thereto. The control device 100 includes a housing 10, a button 30 mounted in the housing 10, and a signal transmitting mechanism (not shown). The button 30 is configured to trigger the signal transmitting mechanism to emit a signal after being pressed. The signal transmitting mechanism can adopt an industry-wide design, and details are not described herein.

The housing 10 includes a front wall 12 and four sidewalls 14 that are coupled to the front wall 12. The four sidewalls 14 are respectively coupled to four sides of the front wall 12. The front wall 12 and the four sidewalls 14 cooperatively define a receiving cavity 16. The receiving cavity 16 is configured to receive the button 30 and the signal transmitting mechanism.

In one embodiment, one of the sidewalls 14 defines a through hole 141 communicating with the receiving cavity 16. The button 30 partially extends through the through hole 141. It can be understood that in other embodiments, the through hole 141 may be defined in the front wall 12.

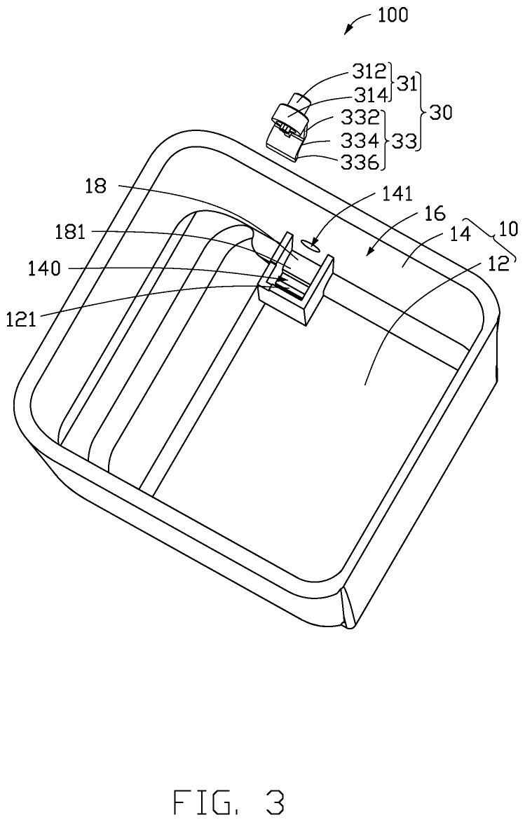

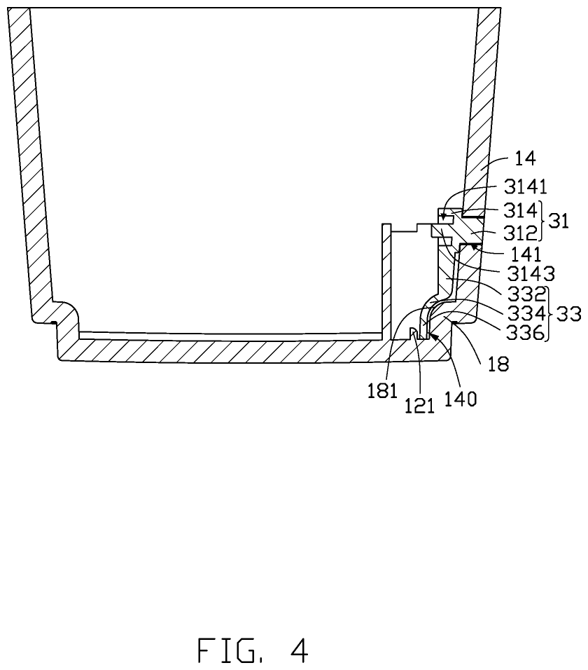

Referring to FIG. 3 and FIG. 4, the button 30 includes a pressing portion 31 and a resilient arm 33. The resilient arm 33 is mounted in the receiving cavity 16. One end of the resilient arm 33 is coupled to the housing 10. The pressing portion 31 is coupled to one end of the resilient arm 33. The pressing portion 31 is slidably mounted in the through hole 141. In one embodiment, the pressing portion 31 slightly protrudes from the sidewall 14. It can be understood that in other embodiments, the end of the pressing portion 31 may be flush with or slightly recessed from the sidewall 14 as long as the pressing portion 31 can be pressed.

In one embodiment, the front wall 12 includes a latching block 121. The latching block 121 is adjacent to the sidewall 14 in which the through hole 141 is mounted and cooperatively defines a latching slot 140 with the sidewall 14. One end of the resilient arm 33 extends away from the pressing portion 31 into the latching slot 140. In one embodiment, a distance between the latching block 121 and the corresponding sidewall 14 is 1.35 mm, but is not limited thereto. It can be understood that in other embodiments, the latching slot 140 may be defined in the front wall 12.

An inner wall of the through hole 141 limits movement of the button 30 along a first direction and a second direction, and the sidewall 14 and the latching block 121 limit movement of the button 30 along a third direction. The first direction, the second direction, and the third direction are substantially perpendicular to each other.

In one embodiment, the resilient arm 33 includes a connecting portion 332, a curved portion 334, and a latching portion 336 coupled together in sequence. The connecting portion 332 is coupled to the pressing portion 31. The latching portion 336 is latched in the latching slot 140. When the pressing portion 31 is pressed, the curved portion 334 is resiliently deformed, and when the pressing portion 31 is released, the pressing portion 31 is resiliently restored.

In one embodiment, the housing 10 includes a positioning block 18. The positioning block 18 includes a curved surface 181 corresponding in shape to the curved portion 334. The positioning block 18 is used to position the curved portion 114. In one embodiment, the positioning block 18 is located between the front wall 12 and the sidewall 14 where the resilient arm is located, but is not limited thereto. In other embodiments, a location of the positioning block 18 is set according to a shape of the curved portion 334.

It can be understood that in other embodiments, the positioning block 18 can be omitted. It can be understood that in other embodiments, the curved portion 334 may be omitted as long as the resilient arm 33 can be elastically deformed.

In one embodiment, a reinforcing block 3321 (shown in FIG. 2) is mounted on the connecting portion 332. The reinforcing block 3321 reinforces the connecting portion 332 to prevent the connecting portion 332 from being deformed. It can be understood that in other embodiments, the reinforcement block 3321 can be omitted.

In one embodiment, one side of the second column 314 facing away from the first column 312 defines a clearance groove 3141. A bottom wall of the clearance groove 3141 includes a pressing rod 3143. The pressing rod 3143 is configured to press and trigger the signal transmitting mechanism. The clearance groove 3141 is for receiving components of the signal transmitting mechanism.

When the button 30 is assembled, the latching portion 336 is first inserted into the latching slot 140, and the pressing portion 31 is pressed to elastically deform the curved portion 334 to fit the pressing portion 31 into the through hole 141.

It can be understood that the button 30 can also be applied to other control devices that require a button trigger mechanism besides a doorbell.

The button 30 of the control device 100 has a simple structure and low manufacturing cost, is easy to assemble, and does not require a fixing member such as a screw to be assembled.

In one embodiment, the through hole 141 is a circular hole. The pressing portion 31 includes a first column 312 and a second column 314 coupled to the first column 312. A diameter of the first column 312 is less than a diameter of the second column 314. The first column 312 is movably mounted through the through hole 141, and the second column 314 is configured to resist against the sidewall 14. The resilient arm 33 is coupled to a peripheral wall of the second column 314. It can be understood that in other embodiments, the second column 314 can be omitted, such that the resilient arm 33 resists against the sidewall 14 to retain the first column 312 in the through hole 141.

When the pressing portion 31 is pressed, the pressing portion 31 slides within the through hole 141 to trigger the signal transmitting mechanism within the housing to emit a signal and causes the resilient arm 33 to deform. When the pressing portion 31 is released, the resilient arm 33 latched in the latching slot 140 is resiliently restored to cause the pressing portion 31 to return to an initial position.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A control device comprising:
a housing; and
a button received within the housing; wherein:
the housing defines a through hole and a latching slot;
the button comprises a pressing portion and a resilient arm;
the pressing portion is slidably mounted within the through hole;
one end of the resilient arm is coupled to the pressing portion, and a second end of the resilient arm is latched within the latching slot;
when the pressing portion is pressed, the pressing portion slides to trigger a signal transmitting mechanism within the housing to emit a signal and causes the resilient arm to deform;
when the pressing portion is released, the resilient arm is resiliently restored to cause the pressing portion to return to an initial position.

2. The control device of claim 1, wherein:
the resilient arm comprises a connecting portion, a curved portion, and a latching portion coupled in sequence;
the connecting portion is coupled to the pressing portion;
the latching portion is latched within the latching slot;
the curved portion is configured to be resiliently deformed.

3. The control device of claim 2, wherein:
the housing comprises a positioning block;
the positioning block comprises a curved surface corresponding in shape with the curved portion to position the curved portion.

4. The control device of claim 2, wherein:
the connecting portion comprises a reinforcing block.

5. The control device of claim 1, wherein:
the pressing portion comprises a first column and a second column;
the first column is coupled to the second column;
a diameter of the first column is less than a diameter of the second column;
the first column is movably received through the through hole;
the second column is configured to resist against the housing;
the resilient arm is coupled to a peripheral wall of the second column.

6. The control device of claim 5, wherein:
one side of the second column facing away from the first column defines a clearance groove for receiving components of the signal transmitting mechanism;
a pressing rod is mounted on a bottom wall of the clearance groove;
the pressing rod is configured to press the signal transmitting mechanism to trigger the signal transmitting mechanism.

7. The control device of claim 1, wherein:
the housing comprises a front wall and four sidewalls coupled to the front wall;
the front wall and the four sidewalls cooperatively define an receiving cavity;
the receiving cavity receives the button and the signal transmitting mechanism;
the through hole is defined in one of the four sidewalls.

8. The control device of claim 7, wherein:
the front wall comprises a latching block;
the latching block and one of the four sidewalls cooperatively define the latching slot.

9. The control device of claim 7, wherein the button is an integrally formed piece.

10. A button comprising:
a pressing portion; and
a resilient arm; wherein:
the pressing portion is slidably mounted within a housing;
one end of the resilient arm is coupled to the pressing portion;
a second end of the resilient arm is configured to latch within the housing;
when the pressing portion is pressed, the pressing portion drives the resilient arm to resiliently deform;
when the pressing portion is released, the resilient arm resiliently restores to cause the pressing portion to return to an initial position.

11. The button of claim 10, wherein:
the resilient arm comprises a connecting portion, a curved portion, and a latching portion coupled together in sequence;
the connecting portion is coupled to the pressing portion;
the latching portion is configured to latch within the housing;
the curved portion is configured to be resiliently deformed.

12. The button of claim 11, wherein:
the pressing portion comprises a first column and a second column;
the first column is coupled to the second column;
a diameter of the first column is less than a diameter of the second column;
the first column is movably received through a through hole defined in the housing;
the second column is configured to resist against the housing;
the resilient arm is coupled to a peripheral wall of the second column.
